(19) United States
(12) Patent Application Publication
(10) Pub. No.: US 2025/0245524 A1
(43) Pub. Date: Jul. 31, 2025

(54) TEMPORAL-RELATIONAL PATH-BASED SEMI-INDUCTIVE TEMPORAL KNOWLEDGE GRAPH FORECASTING

(71) Applicant: NEC Laboratories Europe GmbH, Heidelberg (DE)

(72) Inventors: Julia Gastinger, Heidelberg (DE); Timo Sztyler, Heidelberg (DE)

(21) Appl. No.: 18/776,266

(22) Filed: Jul. 18, 2024

(30) Foreign Application Priority Data
Jan. 31, 2024 (EP) 24155040.9

(51) Int. Cl. G06N 5/02

(52) U.S. Cl. CPC G06N 5/02

(57) ABSTRACT

A computer-implemented method for predicting links in a temporal knowledge graph (TKG) includes determining one or more anchor nodes and computing, from each node to each anchor node of the TKG for each time-step, relational and temporal paths, and temporal and spatial distances. An embedding is determined for each node to a closest anchor node at each time-step using a vocabulary encoder that combines information received from separate encoders configured to encode the paths and distances. The embedding includes a type of relation. Scores are predicted for each embedding at a future time-step using a scoring function. Link prediction is performed to predict how interaction of the nodes change at the future time-step based on the scores. The present disclosure has applications including, but not limited to, use cases in computational biology, medical AI and healthcare, and cyber threat security for optimizing machine learning processes or supporting decision making.

### CROSS-REFERENCE TO PRIOR APPLICATION

Priority is claimed to EP Provisional Application Serial No. EP 24155040, filed on Jan. 31, 2024, the entire contents of which is hereby incorporated by reference herein.

### FIELD

The present disclosure relates to Artificial Intelligence (AI) and machine learning (ML), and in particular to a method, system, data structure, computer program product and computer-readable medium for temporal-relational path-based semi-inductive temporal knowledge graph forecasting.

### BACKGROUND

Predictions of what will occur in the future, or forecasting, has always been an appealing area for exploiting the potential of machine learning solutions, especially in financial, medical, and public safety domains. Classic machine learning-based forecasting methods already work surprisingly well when the input is structured as a time-series, that is, a sequence of values on which the future prediction depends on.

When the values of a time-series are not simple numbers or vectors, but rather complex knowledge graphs (KGs) of interconnected entities, classic machine learning-based methods fail to exploit the structural dependencies between the entities (or nodes) and result in inaccuracies and poor performance. The machine learning field that investigates this particular setup is referred to as temporal knowledge graph (TKG) forecasting.

At each point in the time-series, KGs are typically very large and hard to manually inspect for humans, let alone usable to make predictions, so algorithms are relied on to predict how these KGs will change. In particular, one technical problem is to predict how the interaction between a fixed number of entities will change over time. This is referred to as link prediction. Another technical problem is how to handle new, previously unseen nodes that can arrive, as well as how to make predictions for these new nodes.

### SUMMARY

In an embodiment, the present disclosure provides a computer-implemented method for predicting links in a temporal knowledge graph (TKG). The method includes determining one or more anchor nodes of the TKG, the one or more anchor nodes being a subset of nodes of the TKG, and computing, from each node of the TKG to each anchor node of the TKG for each time-step, a relational path, a temporal path, a temporal distance, and a spatial distance. An embedding is determined for each node of the TKG to a closest anchor node at each time-step using a vocabulary encoder that combines information received from separate encoders configured to encode the relational path, the temporal path, the temporal distance, and the spatial distance. The embedding includes a type of relation for each node of the TKG to the closest anchor node. Scores are predicted for each embedding in the TKG at one or more future time-steps using a scoring function. Link prediction is performed to predict how interaction of the nodes of the TKG change at the one or more future time-steps based on the scores. The present disclosure has applications including, but not limited to, use cases in computational biology, medical AI and healthcare, and cyber threat security for optimizing machine learning processes or supporting decision making.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 schematically illustrates a method and system architecture for KG forecasting according to an embodiment of the present disclosure;

FIG. 2 schematically illustrates an anchor computation with input and output according to an embodiment of the present disclosure;

FIG. 3 schematically illustrates a temporal path computation with input and output according to an embodiment of the present disclosure;

FIG. 4 schematically illustrates a temporal embedding computation with input and output according to an embodiment of the present disclosure in which neural network components and vectors are marked in dotted lines;

FIG. 5 schematically illustrates a link forecaster with input and output according to an embodiment of the present disclosure; and

FIG. 6 is a block diagram of an exemplary processing system, which can be configured to perform any and all operations disclosed herein.

### DETAILED DESCRIPTION

Embodiments of the present disclosure provide solutions to the technical problem of temporal knowledge graph forecasting in a semi-inductive setting by computing spatial-temporal and relational paths to special, important nodes (referred to herein as anchor nodes) in a graph. Embodiments of the present disclosure can be practically applied to a number of use cases. For example, an embodiment of the present disclosure can be integrated in a prevention tool for predicting future scenarios, such as the development of crime cases in the public safety domain, and for predicting relations between these crime cases.

Embodiments of the present disclosure overcome a number of technical problems and enhance the computational functionality of TKG forecasting systems. According to existing technology, TKG forecasting systems have the following technical problems which can be overcome through the enhanced computational functionality provided by embodiments of the present disclosure:
1. Lack of inductive approaches: Most existing methods for TKG forecasting do not work in a semi-inductive setting meaning they cannot compute embeddings for nodes that have not been seen during training. The semi-inductive methods that do exist are either very simple, for example being limited to computing the mean embedding of neighbors and thus having reduced prediction capacities (Sun, H., Zhong, J., Ma, Y., Han, Z., He, K.: Timetraveler: Reinforcement learning for temporal knowledge graph forecasting. In: Moens, M., Huang, X., Specia, L., Yih, S.W. (eds.) Proceedings of the 2021 Conference on Empirical Methods in Natural Language Processing, EMNLP 2021, Virtual Event/Punta Cana, Dominican Republic, 7-11 Nov. 2021. pp. 8306 8319. Association for Computational Linguistics (2021), hereinafter referred to as “Sun et al.”), or require additional textual information (see Ding, Zifeng, et al. “Improving Few-Shot Inductive Learning on Temporal Knowledge Graphs using Confidence-Augmented Reinforcement Learning.” arXiv preprint arXiv: 2304.00613 (2023), hereinafter referred to as “Ding et al.”).
2. Scalability Issues: Path-based methods, which could under certain circumstances be used for a semi-inductive setting, suffer from scalability issues because paths between each pair of nodes have to be computed in order to compute embeddings (see Liu, Y., Ma, Y., Hildebrandt, M., Joblin, M., Tresp, V.: Tlogic: Temporal logical rules for explainable link forecasting on temporal knowledge graphs. In: Thirty-Sixth AAAI Conference on Artificial Intelligence, AAAI 2022, Thirty-Fourth Conference on Innovative Applications of Artificial Intelligence, IAAI 2022, The Twelfth Symposium on Educational Advances in Artificial Intelligence, EAAI 2022 Virtual Event, Feb. 22-Mar. 1, 2022. pp. 41204127. AAAI Press (2022), hereinafter referred to as “Liu et al.”, and Sun et al.).
3. Lack of Explainability: No method exists that can describe which specific nodes are important for the embedding of a node-of-interest, especially if the other nodes are not in the direct neighborhood of a node-of-interest, while working in the semi-inductive setting.

These technical problems greatly limit the flexibility of current TKG forecasting models, with consequent implications in terms of forecasting performance. Embodiments of the present disclosure provide solutions to these technical problems and enhance the computational functionality of TKG forecasting systems by computing time-dependent embeddings for each node based on its temporal and spatial distances and temporal paths to important nodes in the graph.

According to existing technology, there is a static path-based semi-inductive link prediction method referred to as NodePiece (see Galkin, Mikhail, Etienne Denis, Jiapeng Wu, and William L. Hamilton. “NodePiece: Compositional and Parameter-Efficient Representations of Large Knowledge Graphs.” In International Conference on Learning Représentations (2021), hereinafter referred to as Galkin et al.). NodePiece computes node embeddings for static KGs by computing spatial distances. However, the static NodePiece approach cannot take into account that links between nodes change over time, and that paths in a graph are not available at all time-steps. Where NodePiece is able to take into account the spatial distance between two nodes, it is not, however, able to take into account the temporal distance between two nodes, in particular how long it takes that information travels from one node to another node. Further, the static NodePiece approach does not take into account which kind of relations are on the path. Thus, NodePiece is not able to address the problem where there are KGs that change over time and it is desired to predict the future of KGs.

In a first aspect, the present disclosure provides a computer-implemented method for predicting links in a temporal knowledge graph (TKG) includes determining one or more anchor nodes of the TKG, the one or more anchor nodes being a subset of nodes of the TKG, and computing, from each node of the TKG to each anchor node of the TKG for each time-step, a relational path, a temporal path, a temporal distance, and a spatial distance. An embedding is determined for each node of the TKG to a closest anchor node at each time-step using a vocabulary encoder that combines information received from separate encoders configured to encode the relational path, the temporal path, the temporal distance, and the spatial distance. The embedding includes a type of relation for each node of the TKG to the closest anchor node. Scores are predicted for each embedding in the TKG at one or more future time-steps using a scoring function. Link prediction is performed to predict how interaction of the nodes of the TKG change at the one or more future time-steps based on the scores.

In a second aspect, the present disclosure provides the method according to aspect 1, wherein computing the temporal path is performed in an iterative manner by updating the temporal paths in a case that a new edge appears that shortens the temporal path.

In a third aspect, the present disclosure provides the method according to the first or second aspects, wherein computing the relational and temporal paths takes into account time-ordered paths.

In a fourth aspect, the present disclosure provides the method according to any of the first to third aspects, wherein the computing step is repeated for nodes of the TKG with connected triples that appear in new time-steps of the TKG.

In a fifth aspect, the present disclosure provides the method according to any of the first to fourth aspects, wherein each triple includes a subject, a relation, and an object, and wherein the link prediction is performed for a received query for the subject, the relation or the object at the one or more future time-steps.

In a sixth aspect, the present disclosure provides the method according to any of the first to fifth aspects, wherein the one or more anchor nodes are determined using a predefined importance heuristic, and wherein the scoring function is based on a DistMult scoring function.

In a seventh aspect, the present disclosure provides the method according to any of the first to sixth aspects, wherein computing the relational path, the temporal path, the temporal distance, and the spatial distance includes using a Breadth First Search (BFS) that uses the TKG and the one or more anchor nodes and extracts the relational path.

In an eighth aspect, the present disclosure provides the method according to any of the first to seventh aspects, further comprising displaying the relational path, the temporal path, the temporal distance, and the spatial distance, the TKG, and anchor identifiers (IDs) for the one or more anchor nodes.

In a ninth aspect, the present disclosure provides the method according to any of the first to eighth aspects, wherein the separate encoders include a spatial distance encoder configured to encode the spatial distance per anchor node, a temporal distance encoder configured to encode the temporal distance, a relation encoder configured to encode the relational path, a time-step encoder configured to encode the time-steps, and a temporal path encoder configured to encode temporal paths, wherein each temporal path includes encoded relations r and encoded time-steps t to one of the one or more anchor nodes.

In a tenth aspect, the present disclosure provides the method according to any of the first to ninth aspects, wherein a single temporal path is determined for each of the one or more anchor nodes, and wherein the vocabulary encoder combines outputs from the spatial distance encoder, the temporal distance encoder, and the temporal path encoder to determine the embedding for each node of the TKG to the closest anchor node.

In an eleventh aspect, the present disclosure provides the method according to any of the first to tenth aspects, wherein the one or more anchor nodes are predefined by a user.

In a twelfth aspect, the present disclosure provides the method according to any of the first to eleventh aspects, wherein the TKG represents electronic health records and/or smart sensor networks, wherein predicting the link in the TKG is further based on a received query that includes a patient associated with the electronic health records and/or the smart sensor networks, and the link prediction includes a predicted outcome for how a treatment or sequence of treatments will affect the health of the patient.

In a thirteenth aspect, the present disclosure provides the method according to any of the first to twelfth aspects, wherein a respective node of the TKG represents a blood sample of the patient from the electronic health records, and a relation associated with the respective node identifies the patient.

In a fourteenth aspect, the present disclosure provides a computer system for predicting links in a temporal knowledge graph (TKG), the computer system comprising one or more hardware processors which, alone or in combination, are configured to provide for execution of the method according to any of the first to thirteenth aspects.

In a fifteenth aspect, the present disclosure provides a tangible, non-transitory computer-readable medium having instructions thereon which, upon being executed by one or more processors, provide for predicting links in a temporal knowledge graph (TKG) by execution of the method according to any of the first to thirteenth aspects.

Embodiments of the present disclosure provide a method and system to predict future links in a temporal KG:
i. in a semi-inductive setting by computing node embeddings based on paths and spatial and temporal distances in a graph,
ii. in a scalable way by computing paths only to important nodes (anchor nodes), and by updating its paths only for edges at new time-steps, and
iii. in an explainable way, by highlighting which important nodes (anchor nodes) are important for a given prediction.

In an embodiment, the present disclosure provides a method for KG forecasting to predict future links in TKGs based on a TKG that represents the historic information. TKGs are KGs with time information. Triples are extended to quadruples with a fourth element, a time-step, to show that they are valid (known to be present) at this time-step, in particular as (subject, relation, object, time-step). The ML model according to an embodiment of the present disclosure is trained using a TKG that represents historic information.

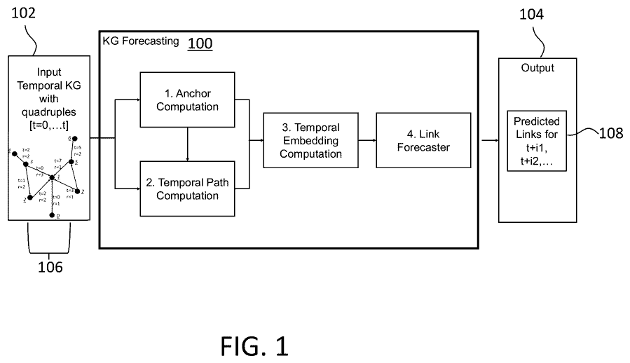

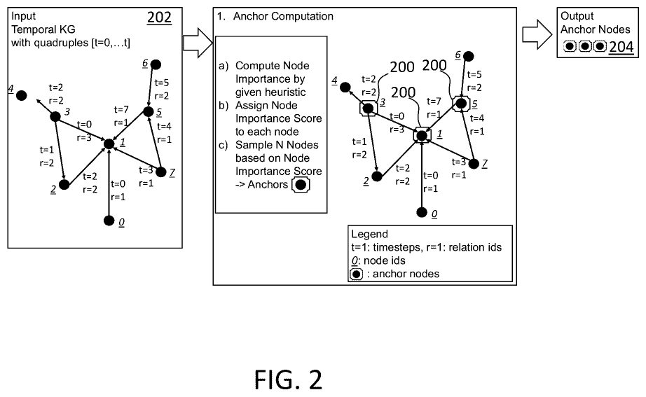

FIG. 1 shows the KG forecasting module 100 with input 102 and output 104, and with its components shown in blocks 1-4, which are described in more detail in the following and in FIGS. 2-5. The input 102 to the KG forecasting module 100 is a TKG 106, represented as quadruples, which represent the historical available information. The number of available time-steps in this input TKG 102 can be specified by the user. The output are the predicted links 108 for given queries (s,r,?,t+x), (?,r,o,t+x), (s,?,o,t+x) at specific future time-steps (x=1, 2, . . . ), where s is subject, r is relation, o is object, and t is time-step. The queries as well as future time-steps of interest x can be specified by the user. Embodiments of the present disclosure work in a discrete setting.

### 1. Anchor Computation:

The anchor computation 1, illustrated in detail in FIG. 2, computes and extracts N anchor nodes 200 for the given TKG 202, where N is a predefined hyperparameter, which can be chosen based on computation capabilities and the particular use case. For example, for a system with limited computation capabilities or limited memory, one would select a smaller value for N, e.g. N=50. This would lead to less anchor nodes, and potentially less fine-grained information, and thus less accuracy, but also need less computation power. An example of how a use case would affect the selection of N: if a use case requires high accuracy (e.g. a crime use case), it might be beneficial to choose a higher number of N and potentially choose a longer computation time/power. Anchor nodes 200 are nodes that are used to represent other nodes in future steps. These anchor nodes 200 are defined to be important nodes. They are computed based on the given input KG 202, but the time information in the quadruples is ignored. In one embodiment, the anchor nodes 200 are computed following the protocol of NodePiece, where they are combined by a predefined heuristic of nodes with high node centrality, page rank, and a small number of random nodes. NodePiece may include employing a deterministic anchor selection strategy where 40% of the total number of anchors |A| are nodes with top Predicate-Augmented Personalized PageRank (PPR) scores, 40% are top degree nodes, and a remaining 20% are selected randomly. This may result in all anchor sets being non-overlapping and disjoint, i.e., if some top degree nodes have already been selected with a PPR policy they will be skipped in favor of next nodes in the sorted list. In another embodiment, the anchor nodes 200 are predefined by the user. In the real world, the anchor nodes could, for example, be nodes that represent important crime solvability information or crime investigation information, for example nodes representing police stations or important contact persons, or closed-circuit television (CCTV) cameras. The output is a list of anchor node identifiers (IDs) 204. In embodiments, IDs exist for all nodes in an initial knowledge graph. The initial knowledge graphs may include a set of node and relation IDs in the form of quadruples [subject node ID, relation ID, object node ID, time-step ID].

### 2. Temporal Path Computation:

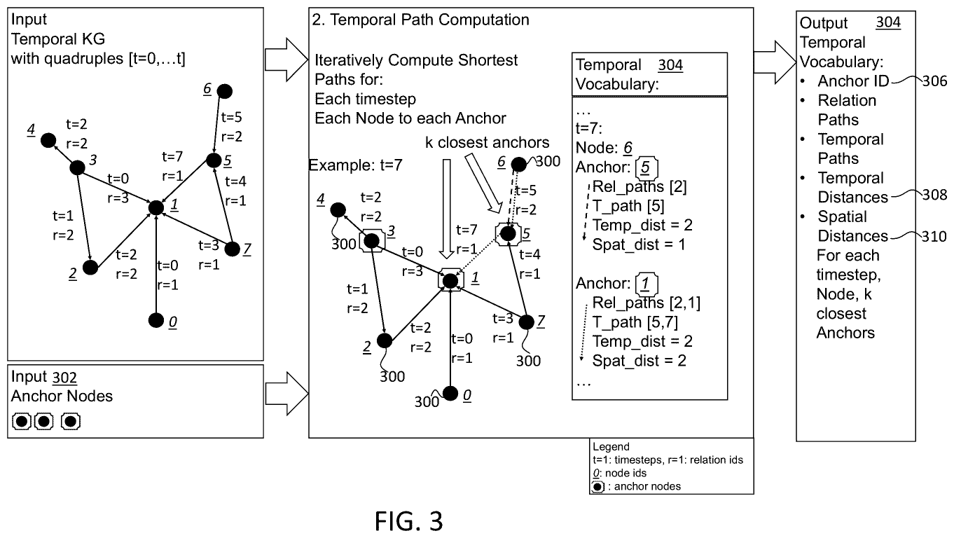

During the temporal path computation 2, illustrated in detail in FIG. 3, paths are computed for each node 300, for each time-step t, to each anchor node 302. The output is referred to as the temporal vocabulary 304. This contains for each time-step t-N: t, for each node:
a list of anchor ids for the k closest anchors 302, where k is a hyperparameter. In embodiments, k can be determined either using a grid search or using a hyperparameter optimization library (e.g. Optuna), or selected randomly to a default value, e.g. 50;
a list with k relation paths, containing the relation ids for the paths from the node 300 to each of the k closest anchors 302. In embodiments, the relation ids may be provided in the dataset. If they are not provided in the dataset they can be assigned subsequently, e.g. 0 for the first relation, 1 for the section relation . . . ;
a list with k time-step paths, containing the time-steps for the paths from the node 300 to each of the k closest anchors 302;
a list of temporal distances to the k closest anchors 302; and
a list of spatial distances to the k closest anchors 302.

The system computes the temporal vocabulary 304 as the distances and paths from each node 300 to the anchor nodes 302, for each time-step, for each anchor 302. One embodiment of the present disclosure computes the spatial and temporal distances and paths in the graph using a temporal version of the breadth first search (BFS) approach. Therefore, it can use a version of the algorithm as proposed in Huang, S., Cheng, J. and Wu, H., 2014. “Temporal graph traversals: Definitions, algorithms, and applications.” arXiv preprint arXiv: 1401.1919 (Definition 8) as a basis and this algorithm is enhanced according to an embodiment of the present disclosure by taking into account that different relations can be found on the path, in particular by also extracting relational paths. Pseudocode 1 below provides further details of this enhanced algorithm.

Embodiments of the present disclosure only update the computed paths for new time-steps as compared to the previous time-steps, if triples that are connected to the nodes 300 on the existing shortest paths (connected triples) appear in new time-steps. If no new connected triples appear, the temporal distance for the new time-steps will be increased (based on the size of the time interval), and the spatial distances as well as relational paths remain untouched.

Pseudocode 1 - Compute Temporal Distances with Breadth First Search (BFS):
Given a temporal KG G = (V, E) and a starting time ts, a BFS in G starting at ts is defined as
follows:
Input:

| | |
|---|---|
| - | Previous_value_list (for each node: s, dist(s), temp_dist(s), p(s), relation_path(s) from |
| | previous time-step for each node s to anchor); where s: node id, dist(s): distance from |
| | node to anchor: How many hops does it take to get from anchor to node, temp_dist(s): |
| | temporal distance between node and anchor - how many time-steps does it take to get |
| | from anchor to node; σ(s): the time-step of the most recent edge on the path; p(s) |
| | previous node (predecessor) on path; relation_path(s) the relationships on the path for |
| | each node s to anchor |
| - | traversed_dict: a dictionary that describes for each temporal edge if it has been |
| | traversed |
| - | KG G = collection of triples, starting time ts=time-step |

Output: Value_list (for each node: s, dist(s), temp_dist(s), σ(s), p(s), relation_path(s) to
anchor A)
1. if Previous_value_list empty: Initialize to empty paths and infinite distances
2. Select a source vertex s, and push (s, dist(s), temp_dist(s), σ(s), p(s), relation_path(s)) into
Q
3. While Q is not empty, do:

| (a) Pop (u, dist(u), temp_dist(u), p(u), relation_path(u)) from Q; | |
|---|---|
| (b) Let Eu,v be the set of temporal edges going from u to v, where each edge (u, v, t) | |
| ∈ Eu,v has not been traversed before and σ(u) ≤ t. | |
| For each out-neighbor v of u, where Eu,v notequalto Ø, do: | |
| i. Let e = (u, v, t) be the edge in Eu,v where t = min{t′ : (u, v, t′) ∈ Eu,v }. | |
| ii. If v is not in Q (whether v has been visited or not): | |
| | traverse e, and if σ(v) > t, then visit v and push (v, dist(v) = dist(u) + 1, |
| | σ(v) = t, p(v) =u, relation_path(v)) into Q. Update traversed_dict |
| iii. Else: | |
| A. | If there exists (v, dist(v), σ(v), p(v), relation_path(v)) in Q such that |
| | dist(v) = dist(u) + 1: traverse e, and if σ(v) > t, then visit v and update |
| | σ(v) = t and p(v) = u, and relation_path(v) in Q. Update traversed_dict |
| B. | Else (i.e., dist(v) = dist(u)): traverse e, and if σ(v) > t, then visit v and |
| | push (v, dist(v) =dist(u) + 1, σ(v) = t, p(v) = u, relation_path(v)) into |
| | Q. Update traversed_dict |

Explainability: By displaying the temporal vocabulary 304 to the user, especially the anchor ids 306 and the distances 308 and 310 to these anchor ids 306, to the user, it can be shown how the embedding of each node is derived, and which anchor nodes 302 are important to these nodes of interest. For example, the temporal vocabulary 304 may be displayed on a user interface, where the numeric values may be presented. In another example the temporal vocabulary 304 may be presented via a table with a line for each anchor, and a column for the ID, a column for the distances, and so on. In a crime solving example, a user interface embedded to a map/visualized knowledge graph could be provided where the user could click on a node of interest and the values would be shown for that node. This is, for example, especially helpful in the crime solving domain, where an embodiment of the present disclosure can be implemented in a tool to highlight which crime factors of interest contribute to the solvability or to the prevention of certain crimes, such as the distance to CCTV, or the distance to police stations.

Scalability: By selecting a relatively small number (as compared to the TKG size), for example 5% of all nodes as the number of anchors, only a small percentage of paths have to be computed (one path from each node to each anchor, as compared to one path form each node to each other node). This significantly enhances scalability, speeds up computation and conserves computational resources.

### 3. Temporal Embedding Computation:

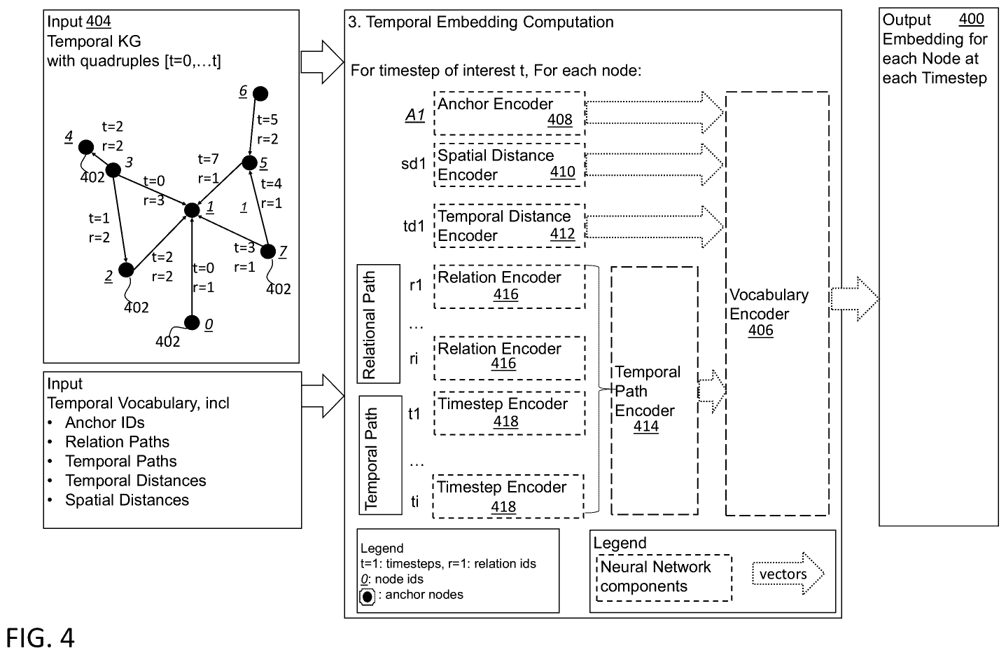

During the temporal embedding computation 3, illustrated in detail in FIG. 4, the embedding for each node 402, for each time-step is computed. The output 400 is a node embedding h (t) for each node 402 in the graph 404 for each future time-step of interest, in particular the time-steps t+i1, t+i2 in FIG. 1. As shown in FIG. 4, the embedding is computed by a vocabulary encoder 406. The vocabulary encoder 406 gets as input:
the encoded anchor Ids, Enc1 (A) for all anchors A, encoded with encoder Enc1 (Anchor Encoder 408);
the encoded spatial distances, Enc2 (sd), where there is one spatial distance per anchor, encoded with encoder Enc2 (Spatial Distance Encoder 410);
the encoded temporal distances, Enc3 (td), where there is one spatial distance per anchor, encoded with encoder Enc3 (Temporal Distance Encoder 412); and
the encoded temporal paths from Temporal Path Encoder 414, that includes TPEnc (Enc4(r) (Relation Encoders 416), Enc5(t) (Timestep Encoders 418)), where each path consists of the encoded relations r and the encoded time-steps t that constitute the paths to the anchors A. There is one path per anchor A, where the path is described by the nodes that are on the path, and the time-steps that are on the path. In embodiments, the vocabulary encoder 406 learns to combine these inputs to a node embedding 400.

The vocabulary encoder 406 learns to combine the above described inputs to a node embedding 400. The vocabulary encoder 406, as well as the encoders Enc1-Enc5 408-412, 416, and 418, and the encoder TPEnc 414 are machine learning models. In one embodiment, the encoders Enc1-Enc5 408-412, 416, and 418, and TPEnc 414, are 1-layer multilayer perceptrons (MLPs) that get as input the ids of the respective anchors, or relations, or the numeric values of the distances. In another embodiment, the encoder for the temporal distances Enc3 412 is a time-step encoder 418 that specifically learns to encode temporal information, e.g., with a cosine function cos(omega*t), where omega is a learnable parameter. In an embodiment, omega can be learned during training of a model where the model is trained in an end-to-end approach, as described below, and one of the parameters is omega.

In one embodiment, the vocabulary encoder 406 is a transformer model that learns to concatenate the input vectors to one node embedding. In another embodiment, the vocabulary encoder 406 is a recurrent neural network that also gets as input the node embedding vector from the previous step, and thus learns how the node embedding evolved over time.

Training: The model is trained for link prediction, where the task is to predict links for future KG snapshots, e.g., (subject, relation, ?, t+i). The KG snapshots are split into a training set, a validation set, and a test set, taking into account the order of time-steps, in particular tₜₑₛₜ>t_{valid}>tₜᵣₐᵢₙ. The node embedding encoders are trained in an end-to-end approach, together with the link forecaster. In one embodiment, cross entropy loss is used to compute the loss between predicted scores for certain links and actual links (ground truth triples).

Semi-Inductiveness: Because a node embedding is computed based on the paths to anchor nodes, only the anchor nodes need to be known at training time. The embeddings for all other nodes can be computed as soon as the node appears for the first time in the TKG.

### 4. Link Forecaster:

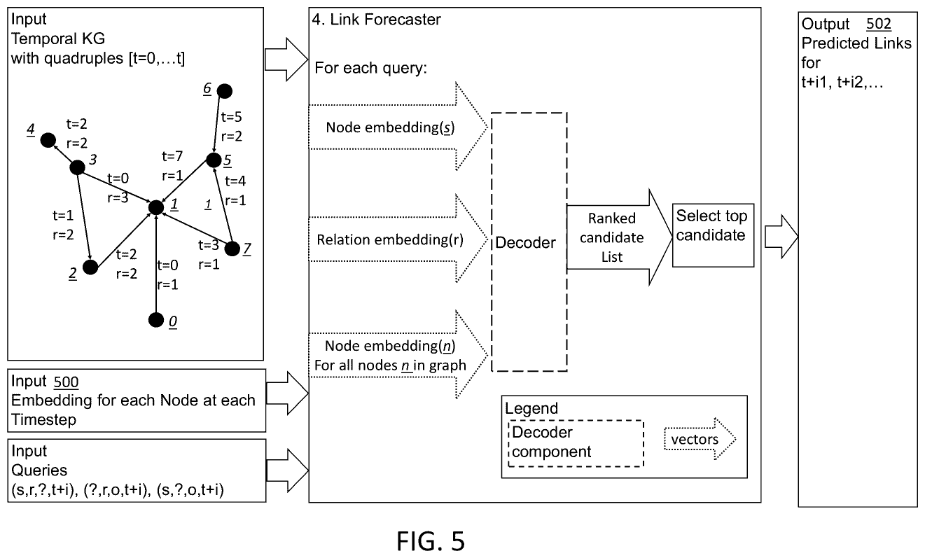

The link forecaster 4 is shown in detail in FIG. 5. By applying a scoring function on top of the computed embeddings 500, the embeddings 500 can be used for link forecasting 502 as follows:

oₜ₊₁=p(hₜ)

where p ( ) is a scoring function.

In an embodiment, the link forecaster 4 may receive an input query (s, r, ?, t+1) which may represent, for example, (person A, visits, ?, tomorrow). For this use case Node embedding(s) of FIG. 5 would be the embedding computed for person A. Node embedding (n) of FIG. 5 would be many different embeddings. For example, if an example knowledge graph has 10,000 nodes, Node embedding (n) would be 10,000 different embeddings: one embedding for each node in the graph. The Decoder of FIG. 5 may combine the embedding for the subject, the embedding for the relation, and the embedding for a candidate node n to compute a score for this candidate node. Each potential node in the graph is a candidate node. By combining the embeddings, the Decoder of FIG. 5 computes a score for each candidate node and then sorts these scores by descending order to obtain the Ranked candidate List of FIG. 5. The scoring function computes scores for given embeddings (for subject, relation, and object) where the triple with the highest computed score is the triple considered most likely. In one embodiment, p ( ) is implemented using the DistMult scoring function. The DistMult scoring function may include a product of a subject embedding, relation embedding, and candidate node embedding. For example, the DistMult scoring function may evaluate the plausibility of each possible object node by computing a score based on the embeddings of the subject, relation, and candidate object nodes, leveraging element-wise multiplication and dot product operations. Some example Steps for this procedure are:
1) Compute Element-wise Product of the subject node embedding and the relation embedding.
2) Compute Scores for Each Object: For each candidate object node embedding compute the score by taking the dot product of the output of Step 1) and the embedding of the respective candidate object node.
3) Rank Object Candidates: Rank all the candidate objects based on their scores. The objects with higher scores are considered more likely to be the correct answer to the query.

When multiple future time-steps are to be computed, the model can be repeated multiple times using a recursive strategy. Although the model can also compute relation embeddings hᵤᵥ by using a scoring function p( ) embodiments of the present disclosure focus on the node embeddings.

Embodiments of the present disclosure thus provide for general improvements to computers in machine learning systems to enhance their functionality to perform temporal knowledge graph forecasting in a semi-inductive setting, while at the same time providing for scalability, increased computational efficiency and explainability. Moreover, embodiments of the present disclosure can be practically applied to use cases to effect further improvements in a number of technical fields including, but not limited to, medical (e.g., digital medicine, personalized healthcare, AI-assisted drug or vaccine development, diagnosis and treatment, etc.), material development, cyberthreat security, public safety (e.g., as a tool to increase crime solvability or for crime prevention) and smart cities (e.g., predictive maintenance, automated traffic or vehicle control, smart districts, smart buildings, smart industrial plants, smart agriculture, energy management, etc.).

An embodiment of the present disclosure can be practically applied to the domain of public safety, for example to provide an action or an action recommendation to increase crime solvability as follows:
Use Case: To increase solvability for crimes, it is important to understand the development of crime cases, and especially crime case investigations over time. This enables timely actions to increase the solvability of a crime. Embedding an embodiment of the present disclosure in a forensic tool for crime case management and action recommendation allows to describe crimes and investigation actions taken to solve those crimes while updating information over time, and allows to predict future outcomes and simulate outcomes when taking certain investigation steps. The temporal capability is of particular interest for dynamically changing situations, and in this case, it is able to take into account the time-order of investigative steps. The semi-inductive capability is especially advantageous to be able to deal with new crime cases, or previously unseen investigative information (e.g., unknown people involved). The output of the system can be used to control other technical devices such as surveillance applications, area monitoring equipment (e.g., cameras or drones), sensors or alarms.
Data Source: Available sensor networks (e.g., cameras, weather stations, and presence sensors), (smart) forensic tools, the database of the police force (e.g., past crime case records), sociodemographic information (e.g., characteristics of the social life in the district of interest), etc.
Application of Method of an Embodiment of the Present Disclosure: Embodiments of the present disclosure enable to predict through temporal knowledge graph forecasting how the knowledge graph changes over time. This includes the expected development of crime cases, the expected outcome of crime cases, and if the expected outcome of crime cases changes given certain investigative steps. Further, embodiments of the present disclosure allow to highlight which nodes are important to compute an embedding for nodes-of-interest. In this case, the anchor nodes can be defined as investigative information (e.g., CCTV cameras and proximity to police stations). With respect to the temporal aspect, as information is collected at different time-steps, the neighborhood of these crime cases changes over time (e.g., availability of information), and new crime cases arrive over time. This new information is incorporated. As one differentiator, embodiments of the present disclosure are able to take into account a) how fast evidence were found (time difference), and b) how cases are related to other important aspects (spatial difference, e.g., to certain locations of interest). Thus, embodiments of the present disclosure enable to compute embeddings for new crimes (semi-inductive setting), and further enable to update the representations over time.
Output: Predicted links for a future time-step of interest. In this case, describing actions that should be taken to increase the solvability of a case, or the expected future solvability of a case.
Technicity: The output of the system can directly be used in the police crime case tools and to act upon technical equipment in crime places, such as cameras, drones, light systems, sensors, etc. The output of the system can control on which investigative steps the police officers should be focused on. The output can be used to control drones for scouting or observing certain areas, or to redirect traffic. Further, when integrated in a mobile application for police officers, the displayed information can interactively guide the police officer how to interact with the device, thereby credibly assisting the user in performing a technical task by means of a continued and/or guided human-machine interaction process.

Another embodiment of the present disclosure can also be practically applied to the domain of public safety, for example for crime prevention as follows:
Use Case: For crime prevention, it is important to understand the development of high-risk areas and potential escalation points in a city or area, ideally before the crimes or accidents happen. This enables timely counteractions such as the presence of more police forces or social workers, as well as the adjustment of those locations (e.g., streetlights should always be turned on in corners that are considered high risk, and public places that are considered dangerous can be equipped with surveillance cameras, or such equipment could be operated). Embedding an embodiment of the present disclosure in a forensic tool for crime prevention allows to continuously evaluate a situation and predict high-risk locations. The output of the system can be used to control other technical devices such as surveillance applications, area monitoring equipment (e.g., cameras or drones), sensors or alarms.
Data Source: Available sensor networks (e.g., cameras, weather stations, and presence sensors), (smart) forensic tools, the database of the police force (e.g., past crime case records), sociodemographic information (e.g., characteristics of the social life in the district of interest), etc.
Application of Method of an Embodiment of the Present Disclosure: Embodiments of the present disclosure enables to predict through temporal knowledge graph forecasting how the knowledge graph that describes a city and its crime cases changes overtime. This includes the expected development of (crime) hotspots. In particular, the occurrence or disappearance of certain properties or events (nodes) and changing relationships (edges) in the (near) future. Anchor nodes can be defined as points of interest in a city, e.g., police stations, schools, banks, prevention centers, train stations, etc. With respect to the temporal aspect, it allows to understand how crime landscapes develop over time, to predict how crimes will develop in future time-steps and to predict how prevention factors influence the future development. As one differentiator, embodiments of the present disclosure are able to take into account how the crime landscape has changed over time and how the crimes are related to other important aspects, and enables to forecast how crime landscape will develop under certain conditions. By the semi-inductive capabilities, it is possible to integrate information about new crimes.
Output: Predicted links for a future time-step of interest. In this case, describing the future development of crimes, and of situations influencing crimes. Further, for each node, the output includes anchors that constitute the vocabulary of this node, and the distances to show how a node embedding for the node is computed and what points of interest influenced the predictions.
Technicity: The output of the system predicts future links describing, for example, certain crimes being likely to happen at future locations in a city given certain paths in the graph. This can be used for automatization of counteractions, e.g., sending drones to high-risk locations, operating area monitoring equipment, alarms or sensors, or providing an automated increase of light systems in the area of risk.

Another embodiment of the present disclosure can also be practically applied to the healthcare domain, for example using electronic health records (EHRs) for patient treatment as follows:
Use Case: When treating a patient, e.g., in a hospital, it is common to assign a treatment and then observe the effect. This is an iterative process in that the medical doctor assigns treatments, observes the outcome, and then plans the follow-up treatment. Treatments comprise, for example, administering medications, scheduling therapy sessions, or preparing for a surgical procedure. An embodiment of the present disclosure can be embedded in a computer tool to support the healthcare professionals by predicting the future health effects of treatments, also considering the time between a treatment and an outcome, as well as the time that is needed between treatment steps (e.g., medication and manual therapy sessions) to make consistent and well-scheduled decisions.
Data Source: EHRs, data from a patient case management system, publicly available databases, smart sensor networks (e.g., for blood pressure, temperature, and heart rate measurements), etc.
Application of Method of an Embodiment of the Present Disclosure: The method according to an embodiment of the present disclosure takes historical patient records and the patient of interest as input to predict the outcome of a treatment for a given disease. It models the treatment steps, patients, and outcomes as a TKG. It predicts through temporal knowledge graph forecasting how a certain treatment will affect the patient health. Further, it shows which important nodes in the graph (anchors representing treatment steps) are causing the predictions.
Output: Information on how a certain treatment, or a sequence of treatments will affect the health of a patient. By predicting the outcome for various alternative treatment plans, and comparing the predicted outcomes, it is possible to find a recommended treatment plan.
Technicity: To automatically apply the recommended action, an embodiment of the present disclosure can be integrated with technical devices such as Internet of Things (IoT) devices, wearable health trackers, patient monitoring systems, and medication management systems (e.g., pill dispensers). It is also possible to automatically reserve treatments or hospital beds in hospital management systems, or to automatically generate prescriptions. It is further possible to operate alarm systems, dispatch emergency services, or activate automated alerts based on the output.

Another embodiment of the present disclosure can also be practically applied to a smart city, for example for predictive maintenance as follows:
Use Case: In a smart city, buildings like bridges and towers, but also urban vehicles like buses and trams need (regular) maintenance. Early detection of issues saves resources and avoids accidents. A city sensor network including, for example, optical, sound, and inertial sensors including cameras capture the situation and states of the various entities (e.g., a bridge). Further, consideration of temporal events such as the traffic flow and the varying load enables an accurate assessment of the situation, in particular how, for example, a bridge is used and how this effects the state of the bridge over time.
Data Source: Available sensor networks (e.g., cameras, weather stations, and presence sensors), public and governmental databases (e.g., past case records), sociodemographic information (e.g., characteristics of the social life in the district of interest), etc.
Application of Method of an Embodiment of the Present Disclosure: Embodiments of the present disclosure enables to predict through temporal knowledge graph forecasting how the knowledge graph changes over time. This includes the expected development of maintenance states. In particular, the occurrence or disappearance of certain properties or events (nodes) and changing relationships (edges) in the (near) future allow to capture multivariate anomalies. Via the semi-inductive setting, embeddings and predictions can also be computed for nodes that were not available during training time.
Output: Predicted triples, describing the future development, in particular how the relationships between the entities change. For any detected anomaly, the contribution of different signals (e.g., nodes occur or vanish) can be helpful in explaining the anomaly and analyzing the root cause.
Technicity: The output of the system can directly be used to reroute traffic or reduce useable lanes to reduce the load on a bridge, operate road traffic signs, issue area alerts (e.g., to smartphones in an area or to traffic control authorities or systems), lock/block elevators in a building or adapt the permitted weight, lock/block trams/buses automatically from usage to avoid accidents, evacuate a building (e.g., operating alarm such as in the case of fire or an earthquake), etc.

In an embodiment, the present disclosure provides a method for predicting future knowledge graphs, the method comprising the steps of:
1) Record and collect data and organize it in KG snapshots (if not already available).
2) Anchor computation: find or define the important nodes in the TKG, in particular the anchor nodes (see FIG. 2). By defining only a subset of the TKG nodes as anchor nodes, embodiments of the present disclosure enable to improve computation times, conserve computational resources and provide for scalability.
3) Temporal path computation: compute a relational and temporal path from each node to each anchor node for each time-step in the TKG, as well as the temporal and spatial distances from each node to the anchor nodes (see FIG. 3).
   a. Take into account that paths can only be walked on increasing time-steps to take into account the time-ordered paths only.
   b. Compute the paths in an iterative way, in particular only update paths and distances if new edges appear that shorten the paths.
   c. Provide explainability by displaying the anchor nodes and distances for nodes of interest. The nodes of interest may depend on the user or use case. For example, if a user in a crime example is interested in certain points of interest that are displayed in the graph, like a node representing a city square or certain places that are known for crimes, would be examples of nodes of interest.
4) Temporal embedding computation: encode a node by its temporal vocabulary, in particular its closest anchors, the relational and temporal paths, and the temporal and spatial distances leading to these closest anchors (see FIG. 4).
   a. Use several separate encoders to encode information about the temporal and spatial distances, the anchor nodes, and the temporal-relational paths.
   b. Use a vocabulary encoder to combine the information encoded by the separate encoders.
5) Link forecasting: predict scores for each node/triple in future time-step(s) using a scoring function based on the temporal embeddings computed in the preceding step (see FIG. 5).
6) Output predictions for links in the TKG in future time-steps.

Embodiments of the present disclosure provide for the following improvements and technical advantages over existing technology:
1. Computing a node embedding in a TKG based on its spatial-temporal distance and relational-temporal paths to important nodes.
   a. While integrating information about the time that has passed since the node has been connected to the important nodes.
   b. While integrating which kind of relations are on the paths, in particular by integrating the type of connection to the anchor nodes.
2. Computing the temporal paths for each time-step in an iterative way, where path computation is only updated for a new time-step if new edges appear that lead to shorter paths, thereby reducing computation times and conserving computational resources as compared to recomputing the full paths in each iteration.

Liu et al. describe an approach called TLogic that learns and applies temporal logic rules, and finds temporal random walks through the graph. However, in contrast to embodiments of the present disclosure, TLogic is only able to take into account paths up to a certain length. For large graphs, it can only compute and apply paths of length 1 or 2, because it suffers from memory and speed issues due to traversing edges from all nodes to all nodes.

Sun et al. describe an approach called TimeTraveler that also uses reinforcement learning to find temporal walks. The agent starts from the node that is known in a query and walks through outgoing edges across graph snapshots. The actions are sampled according to transition probabilities. These probabilities are computed taking into account dynamic query embeddings the history of paths, as well as the candidate actions. In contrast to embodiments of the present disclosure which can be applied in a semi-inductive setting, TimeTraveler computes embeddings only by taking the mean over 1-hop embeddings, leading to inaccurate predictions. Further, in contrast to embodiments of the present disclosure, it does not provide explainability.

Ding et al. describe an approach called FitCarl that also uses reinforcement learning to answer a query. To better address the data scarcity problem in the setting for new or not-often appearing nodes, a specific module computes the confidence of each candidate action and integrates it into the policy for action selection. It integrates additional external textural information on entities to improve model performance. Therefore, it required this additional textual information.

In contrast to the existing technology including TLogic, TimeTraveler and FitCarl, embodiments of the present disclosure provide for the following improvements:
1. Semi-inductive capabilities: The method according to embodiments of the present disclosure work in a semi-inductive setting, and can thereby accurately compute embeddings for nodes that have not been seen during training. This is an additional feature providing enhanced computer functionality of TKG forecasting systems. It is especially advantageous in particular use cases such as the ones described above, for example to predict important links and embeddings for new crimes in a police system. In contrast to TimeTraveler, the TKG forecasting system according to an embodiment of the present disclosure has an enhanced way of computing the embeddings and provides for improved computational performance and higher prediction accuracy. In contrast to FitCarl, the TKG forecasting system according to an embodiment of the present disclosure does not need additional textual information and is thus more generalizable.
2. Scalability: By computing paths only to anchor nodes, and by having the possibility to set the number and set of anchor nodes flexibly, depending on the use case, the TKG forecasting system according to an embodiment of the present disclosure is more scalable as compared to approaches that compute paths between all nodes. By being able to select the anchor nodes manually, users can define which nodes are important for the given use case, and thus a better accuracy for given use cases is provided for.
3. Explainability: By describing which specific nodes are important for the embedding of a node-of-interest, and also for nodes that are many hops away from the node-of-interest, the output of the TKG forecasting system according to an embodiment of the present disclosure is more intuitively understandable as compared to other approaches, which will lead to increased confidence, security and trust, and a higher acceptance in technical domains of different use cases.

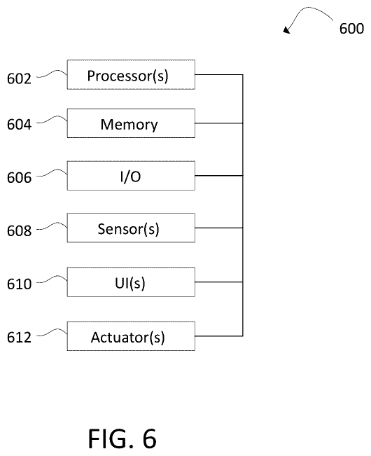

Referring to FIG. 6, a processing system 600 can include one or more processors 602, memory 604, one or more input/output devices 606, one or more sensors 608, one or more user interfaces 610, and one or more actuators 612. Processing system 600 can be representative of each computing system disclosed herein.

Processors 602 can include one or more distinct processors, each having one or more cores. Each of the distinct processors can have the same or different structure. Processors 602 can include one or more central processing units (CPUs), one or more graphics processing units (GPUs), circuitry (e.g., application specific integrated circuits (ASICs)), digital signal processors (DSPs), and the like. Processors 602 can be mounted to a common substrate or to multiple different substrates.

Processors 602 are configured to perform a certain function, method, or operation (e.g., are configured to provide for performance of a function, method, or operation) at least when one of the one or more of the distinct processors is capable of performing operations embodying the function, method, or operation. Processors 602 can perform operations embodying the function, method, or operation by, for example, executing code (e.g., interpreting scripts) stored on memory 604 and/or trafficking data through one or more ASICs. Processors 602, and thus processing system 600, can be configured to perform, automatically, any and all functions, methods, and operations disclosed herein. Therefore, processing system 600 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 600 can be configured to perform task “X”. Processing system 600 is configured to perform a function, method, or operation at least when processors 602 are configured to do the same.

Memory 604 can include volatile memory, non-volatile memory, and any other medium capable of storing data. Each of the volatile memory, non-volatile memory, and any other type of memory can include multiple different memory devices, located at multiple distinct locations and each having a different structure. Memory 604 can include remotely hosted (e.g., cloud) storage.

Examples of memory 604 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 604.

Input-output devices 606 can include any component for trafficking data such as ports, antennas (i.e., transceivers), printed conductive paths, and the like. Input-output devices 606 can enable wired communication via USB®, DisplayPort®, HDMI®, Ethernet, and the like. Input-output devices 606 can enable electronic, optical, magnetic, and holographic, communication with suitable memory 606. Input-output devices 606 can enable wireless communication via WiFi®, Bluetooth®, cellular (e.g., LTE®, CDMA®, GSM®, WiMax®, NFC®), GPS, and the like. Input-output devices 606 can include wired and/or wireless communication pathways.

Sensors 608 can capture physical measurements of environment and report the same to processors 602. User interface 610 can include displays, physical buttons, speakers, microphones, keyboards, and the like. Actuators 612 can enable processors 602 to control mechanical forces.

Processing system 600 can be distributed. For example, some components of processing system 600 can reside in a remote hosted network service (e.g., a cloud computing environment) while other components of processing system 600 can reside in a local computing system. Processing system 600 can have a modular design where certain modules include a plurality of the features/functions shown in FIG. 6. For example, I/O modules can include volatile memory and one or more processors. As another example, individual processor modules can include read-only-memory and/or local caches.

While embodiments of the disclosure have been illustrated and described in detail in the drawings and foregoing description, such illustration and description are to be considered illustrative or exemplary and not restrictive. It will be understood that changes and modifications may be made by those of ordinary skill within the scope of embodiments of the present disclosure. In particular, the present disclosure covers further embodiments with any combination of features from different embodiments described herein. Additionally, statements made herein characterizing the invention or disclosure refer to an embodiment of the invention or disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for predicting links in a temporal knowledge graph (TKG), the computer-implemented method comprising:
determining one or more anchor nodes of the TKG, the one or more anchor nodes being a subset of nodes of the TKG;
computing, from each node of the TKG to each anchor node of the TKG for each time-step, a relational path, a temporal path, a temporal distance, and a spatial distance;
determining an embedding for each node of the TKG to a closest anchor node at each time-step using a vocabulary encoder that combines information received from separate encoders configured to encode the relational path, the temporal path, the temporal distance, and the spatial distance, the embedding including a type of relation for each node of the TKG to the closest anchor node;
predicting scores for each embedding in the TKG at one or more future time-steps using a scoring function; and
performing link prediction to predict how interaction of the nodes of the TKG change at the one or more future time-steps based on the scores.

2. The computer-implemented method according to claim 1, wherein computing the temporal path is performed in an iterative manner by updating the temporal paths in a case that a new edge appears that shortens the temporal path.

3. The computer-implemented method according to claim 1, wherein computing the relational and temporal paths takes into account time-ordered paths.

4. The computer-implemented method according to claim 1, wherein the computing step is repeated for nodes of the TKG with connected triples that appear in new time-steps of the TKG.

5. The computer-implemented method according to claim 4, wherein each triple includes a subject, a relation, and an object, and wherein the link prediction is performed for a received query for the subject, the relation or the object at the one or more future time-steps.

6. The computer-implemented method according to claim 1, wherein the one or more anchor nodes are determined using a predefined importance heuristic, and wherein the scoring function is based on a DistMult scoring function.

7. The computer-implemented method according to claim 1, wherein computing the relational path, the temporal path, the temporal distance, and the spatial distance includes using a Breadth First Search (BFS) that uses the TKG and the one or more anchor nodes and extracts the relational path.

8. The computer-implemented method according to claim 1, further comprising displaying the relational path, the temporal path, the temporal distance, and the spatial distance, the TKG, and anchor identifiers (IDs) for the one or more anchor nodes.

9. The computer-implemented method according to claim 1, wherein the separate encoders include a spatial distance encoder configured to encode the spatial distance per anchor node, a temporal distance encoder configured to encode the temporal distance, a relation encoder configured to encode the relational path, a time-step encoder configured to encode the time-steps, and a temporal path encoder configured to encode temporal paths, wherein each temporal path includes encoded relations r and encoded time-steps t to one of the one or more anchor nodes.

10. The computer-implemented method according to claim 9, wherein a single temporal path is determined for each of the one or more anchor nodes, and wherein the vocabulary encoder combines outputs from the spatial distance encoder, the temporal distance encoder, and the temporal path encoder to determine the embedding for each node of the TKG to the closest anchor node.

11. The computer-implemented method according to claim 1, wherein the one or more anchor nodes are predefined by a user.

12. The computer-implemented method according to claim 1, wherein the TKG represents electronic health records and/or smart sensor networks, wherein predicting the link in the TKG is further based on a received query that includes a patient associated with the electronic health records and/or the smart sensor networks, and the link prediction includes a predicted outcome for how a treatment or sequence of treatments will affect the health of the patient.

13. The computer-implemented method according to claim 12, wherein a respective node of the TKG represents a blood sample of the patient from the electronic health records, and a relation associated with the respective node identifies the patient.

14. A computer system for predicting links in a temporal knowledge graph (TKG), the computer system comprising one or more hardware processors which, alone or in combination, are configured to provide for execution of the following steps:
determining one or more anchor nodes of the TKG, the one or more anchor nodes being a subset of nodes of the TKG;
computing, from each node of the TKG to each anchor node of the TKG for each time-step, a relational path, a temporal path, a temporal distance, and a spatial distance;
determining an embedding for each node of the TKG to a closest anchor node at each time-step using a vocabulary encoder that combines information received from separate encoders configured to encode the relational path, the temporal path, the temporal distance, and the spatial distance, the embedding including a type of relation for each node of the TKG to the closest anchor node;
predicting scores for each embedding in the TKG at one or more future time-steps using a scoring function; and
performing link prediction to predict how interaction of the nodes of the TKG change at the one or more future time-steps based on the scores.

15. A tangible, non-transitory computer-readable medium having instructions thereon which, upon being executed by one or more processors, provide for predicting links in a temporal knowledge graph (TKG) by execution of the following steps:
determining one or more anchor nodes of the TKG, the one or more anchor nodes being a subset of nodes of the TKG;
computing, from each node of the TKG to each anchor node of the TKG for each time-step, a relational path, a temporal path, a temporal distance, and a spatial distance;
determining an embedding for each node of the TKG to a closest anchor node at each time-step using a vocabulary encoder that combines information received from separate encoders configured to encode the relational path, the temporal path, the temporal distance, and the spatial distance, the embedding including a type of relation for each node of the TKG to the closest anchor node;
predicting scores for each embedding in the TKG at one or more future time-steps using a scoring function; and
performing link prediction to predict how interaction of the nodes of the TKG change at the one or more future time-steps based on the scores.
